(19) United States
(12) Patent Application Publication
(10) Pub. No.: US 2013/0258678 A1
(43) Pub. Date: Oct. 3, 2013

(54) ILLUMINATED PANEL AND METHOD FOR MANUFACTURING AN ILLUMINATED PANEL

(71) Applicant: APOLLO DESIGN TECHNOLOGY, INC., Fort Wayne, IN (US)

(72) Inventors: Joel A. Nichols, Fort Wayne, IN (US); Kenneth A. Snyder, Fort Wayne, IN (US); Jason C. Kabot, Huntertown, IN (US); Tracie H. Schmidt, Fort Wayne, IN (US)

(73) Assignee: APOLLO DESIGN TECHNOLOGY, INC., Fort Wayne, IN (US)

(21) Appl. No.: 13/799,544

(22) Filed: Mar. 13, 2013

Related U.S. Application Data
(60) Provisional application No. 61/616,666, filed on Mar. 28, 2012.

(51) Int. Cl. F21V 11/16; B41J 2/435

(52) U.S. Cl. CPC F21V 11/16; B41J 2/435
USPC 362/351; 101/483

(57) ABSTRACT

A method of making an illuminated panel for projecting a pattern or an image and for use with a lighting system including a light source includes the step of providing a substrate. The method further includes the step of printing at least one layer of ink on the substrate to create an image or pattern that may be projected onto a surface, wherein the at least one layer of ink is a light absorbent or light reflective layer of ink that protects the substrate and ink from light energy, ultraviolet light, and infra-red energy.

### CROSS REFERENCE TO RELATED APPLICATIONS

This application claims benefit of priority under 35 U.S.C. §119(e) to copending U.S. Provisional Application No. 61/616,666, filed Mar. 28, 2012, the content of which is incorporated herein by reference in its entirety.

The present disclosure relates generally to methods and apparatuses for projecting light from luminaires, and more particularly, to a panel for illumination and projection of images or patterns and a method of manufacturing the panel.

### BACKGROUND

It is oftentimes desired to project images, patterns, or colored light onto a background, wall, or other structure in an entertainment and an architectural setting. Luminaires or lighting units have been utilized in combination with images or patterns to create these projections or colored light. A common term of art used for a substrate, screen, mat, or other material having an image or pattern for projection by light is “gobo.”

Gobos, which are a form of illuminated panel, may include images or patterns that are sharply focused, for example, corporate logos, regular or irregular patterns, or elements of stage scenery. Alternatively or in addition, the images or patterns on the gobos may be designed to suggest a mood or environment on a stage, such as a pattern suggesting light passing through leaves on a tree.

Gobos may commonly be used in theatres, television studios, concert venues, theme parks, night clubs, retail premises, offices, exhibition halls, and other venues. Gobos may be manufactured from a range of materials, such as metal, glass or plastic and are typically produced in a range of standard sizes and patterns designed to fit common luminaires so that they are easily inserted and removed into an appropriate point of the optical train of that luminaire.

An example of a typical layout for a illuminated panel system 10 is shown in FIG. 1. A luminaire may contain a light source 12 and light gathering system 14. Light is directed from the light source 12 to the light gathering system 14 where collimated light from the light gathering system 14 is directed through an illuminated panel or gobo 16. The illuminated panel 16 may contain transparent, partially transparent, colored and/or opaque areas so as to represent desired images and/or patterns. For example, the pattern shown in FIG. 1 is depicted as a five pointed star for illustrative purposes. In practice, any desired shape, pattern, image, or picture may be used. The illuminated panel 16 may be supported by, attached to, or otherwise retained in a frame or holder 18. The frame 18, in turn, may be supported by, attached to, or otherwise retained within the light gathering system 14 or a separate structure (not shown).

Still referring to FIG. 1, light emerging from illuminated panel 16 may be focused and directed by further optical systems within the luminaire (not shown), and the light is emitted from the luminaire, and finally impinges on projection surface 20, where an image 22 of the illuminated panel 16 is displayed. Such illuminated panel optical systems are well known and may be similar to those used for displaying photographic slides or images from a projector. The light source 12 may be a high intensity light source, such as a high power halogen incandescent lamp, high intensity discharge (HID) lamp, plasma lamp, light emitting diode (LED) light source, or any other light source known in the art.

A typical layout for an illuminated panel system 10 utilizing an automated luminaire 30 is depicted in FIG. 2. The automated luminaire 30 may contain a light source 32 and a light gathering system 34. Similar to FIG. 1, light is directed from the light source 32 to the light gathering system 34 where collimated light beams 35 from the light gathering system 34 are directed through an illuminated panel 36. The illuminated panel 36 is mounted on a wheel 38, which may contain a number of additional illuminated panels 40, which may be different. The wheel 38 may be rotated in a clockwise or counterclockwise directed as indicated by arrow 42. Rotation of the wheel 38 allows for selecting a desired illuminated panel 36, 40, which moves the desired illuminated panel 36, 40 into the light beams 35. The illuminated panels 36, 40 may contain transparent, partially transparent, colored and/or opaque areas so as to represent desired images and/or patterns. The illuminated panel 36 of FIG. 2 is similar to the illuminated panel 16 of FIG. 1. Light beams 44 emerging from the illuminated panel 36 may be focused and directed by further optical systems within the luminaire (not shown), are emitted from the automated luminaire, and finally impinge on a projection surface 46, where an image 48 of the illuminated panel 36 is displayed. The light source 32 again may be a high intensity light source such as a high power halogen incandescent lamp, high intensity discharge (HID) lamp, plasma lamp, LED light source, or any other light source known in the art.

The light beams from high intensity light sources 12, 32 shown in FIG. 1 and FIG. 2, respectively, may contain infra-red (IR) energy or heat and/or ultra-violet (UV) energy, which are damaging to, and may degrade, the respective illuminated panel 16, 36. To combat this degradation, various protection techniques are used in the manufacture of the illuminated panel 16, 36. For example, illuminated panels may be manufactured from metal, such as stainless steel or aluminum, which is capable of withstanding high temperatures for long periods of time. The image is produced in the metal by removing parts of the metal plate, leaving apertures through which the light can pass. This metal removal may be achieved through, for example, stamping, photolithographic etching techniques, and/or by cutting the material using a high powered laser. A problem with such metal illuminated panels is the necessity of leaving connecting tracks or traces between the remaining areas of metal so that the structure remains integral and self-supporting. For example, an innermost portion of the star shape shown in FIG. 1 would need to remain connected to an outermost portion of the pattern by trackes or traces. These connecting tracks or traces are undesirable as they are often visible in the projected image as objectionable lines. Further, such connecting tracks or traces are very susceptible to damage from the IR and/or UV energy in the light beam, and may melt or oxidize the illuminated panel in use.

An improved technique is to produce an illuminated panel in an opaque or reflecting layer deposited on a transparent substrate, such as glass. The supporting glass substrate removes the need for connecting tracks or traces and produces a clean image. In similar processes to those used for metal illuminated panels, areas of the opaque layer may be removed from the glass through photolithographic etching techniques, or by ablating the material using a high powered laser. The illuminated panels described are simple, monochrome, black and white patterns; however, such techniques have been further extended to produce colored images through the use of dichroic coatings on the glass substrate. These coatings may be selectively removed in a similar way to the opaque or reflective layers previously described. Through the use of multiple overlaid layers of differently colored material, and multiple etching or ablation steps, illuminated panels with multiple color and full-color photographically realistic images may be produced.

A problem with metal or dichroic or metal coated glass illuminated panels is that the materials and processes used in manufacture of the illuminated panels are both time consuming and expensive. Additionally, the serial processes needed to produce illuminated panels with colored images often reduce product yields, leading to higher costs and long manufacturing times.

More recently, with the increasing use of LED light sources, which produce much lower amounts of damaging light energy, there have been attempts to manufacture illuminated panels on polymer or plastic substrates through screen printing or other printing techniques, such as those used to produce overhead projections slides. These products have the advantages of being simple, quick, and inexpensive to manufacture. However, the inks used suffer from low contrast, poor blacks, and washed out colors. In addition, the colors and substrate can be quickly damaged by the energy in light sources, even LEDs. In particular, the blue LED used to excite yellow phosphors in many white light LEDs is very energetic and may be damaging to many dyes and inks.

### SUMMARY

Illuminated panels for use in architectural and entertainment luminaires are disclosed that are less expensive and simpler to manufacture than existing illuminated panels, but that provide resistance to the damage caused by high energy lights and IR and UV energies.

According to an illustrative embodiment, a method of making an illuminated panel for projecting a pattern or an image and for use with a lighting system including a light source is provided. The method includes the steps of providing a substrate and printing at least one layer of ink on the substrate to create an image or pattern that may be projected onto a surface, wherein the at least one layer of ink is a light absorbent or light reflective layer that protects the substrate and ink from light energy, ultraviolet light, and infra-red energy.

According to a further illustrative embodiment, an illuminated panel for projecting an image or pattern and for use with a lighting system includes a substrate and a coating of an adhesion promoter disposed on a surface of the substrate. A first layer of ink is deposited on the coating, the first layer of ink being absorptive, and a second layer of ink is deposited on the coating, the second layer of ink being reflective. The first and second layers of ink combine to form an image or pattern for projection.

According to another illustrative embodiment, an illuminated panel for projecting an image or pattern and for use with a lighting system includes a transparent substrate and a coating of an adhesion promoter disposed on a surface of the substrate. The illuminated panel further includes a first layer of ink deposited on the coating, the first layer of ink being absorptive, and a second layer of ink deposited on the coating, the second layer of ink being reflective. A protective layer is disposed on the substrate over the first and second layers of ink. The first and second layers of ink combine to form an image or pattern for projection.

Other aspects and advantages of the present disclosure will become apparent upon consideration of the following drawings and detailed description, wherein similar structures have similar reference numbers.

### BRIEF DESCRIPTION OF THE DRAWINGS

The detailed description particularly refers to the accompanying figures in which like reference numerals indicate like features and wherein:

FIG. 1 illustrates a typical prior art illuminated panel projection system;

FIG. 2 illustrates a further typical prior art illuminated panel projection system utilizing an automated luminaire;

FIG. 3 illustrates an exploded view of a first exemplary embodiment of a illuminated panel;

FIG. 4A illustrates a plan view of the illuminated panel of FIG. 3;

FIG. 4B illustrates an exploded side elevation view of the illuminated panel of FIG. 3;

FIG. 5 illustrates the illuminated panel of FIG. 3 within an illuminated panel projection system; and

FIG. 6 illustrates a second exemplary embodiment of an illuminated panel.

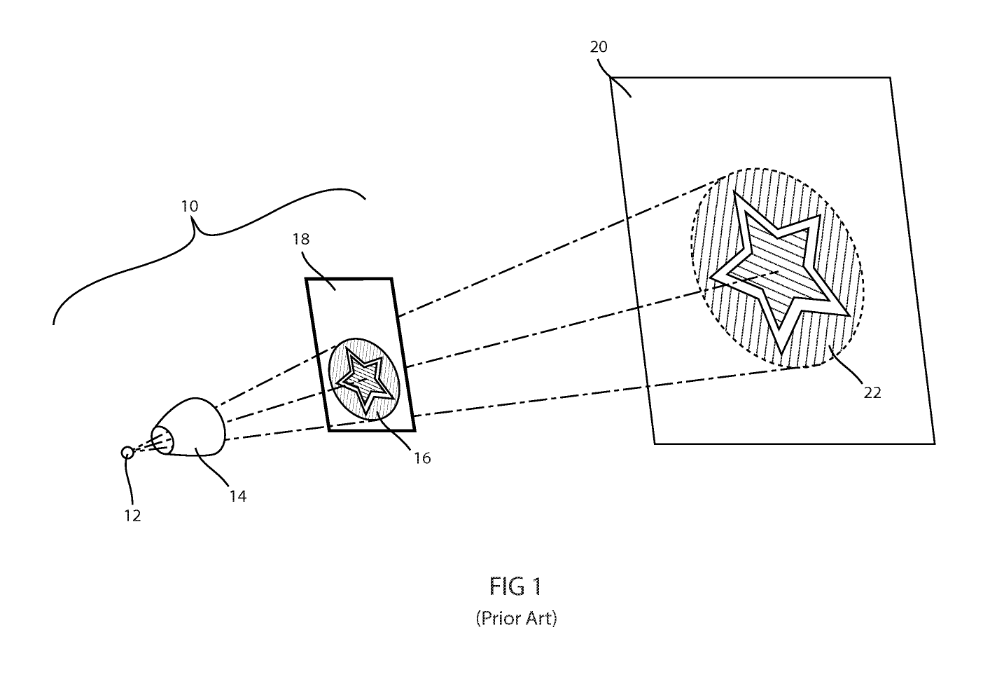

### DETAILED DESCRIPTION OF THE INVENTION

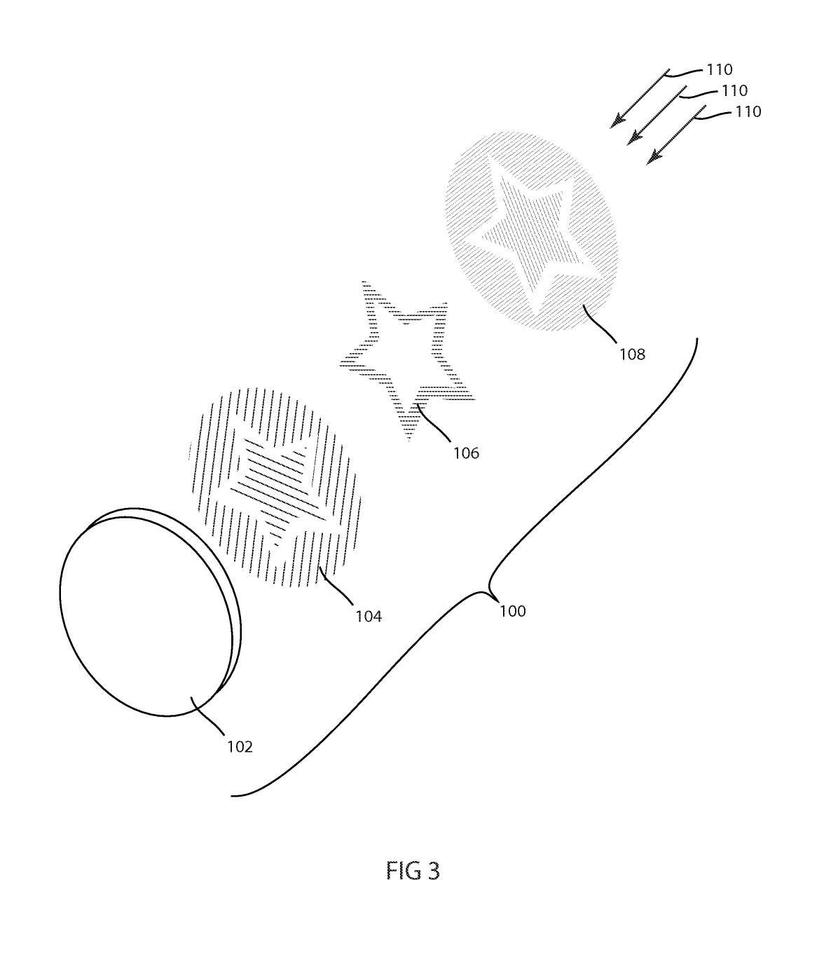

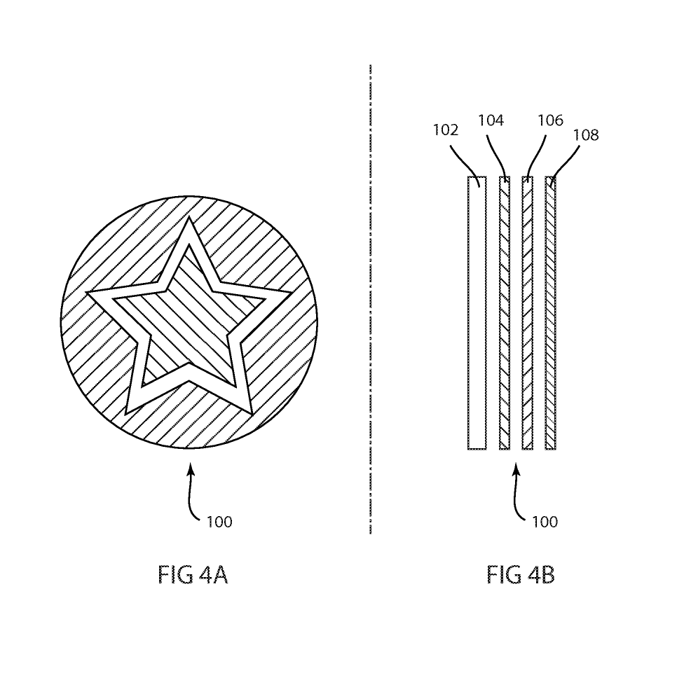

A first embodiment of an illuminated panel 100 is depicted in FIGS. 3, 4A, and 4B. The illuminated panel 100 includes a transparent substrate 102, which may be manufactured of any suitable transparent material, such as glass, polycarbonate, polyester, acrylic, or other material known in the art. The transparent substrate 102 is overprinted with one or more layers of ink, for example, a first layer 104, a second layer 106, and a third layer 108 through a bubble jet, ink-jet, laser, or any other suitable printer. The printer may be a multi-layer high resolution printer, capable of over-printing. The inks utilized for layers 104, 106 and 108 may be flexible inks that are cured and hardened by exposure to UV radiation. The inks used for layers 104, 106, and 108 may be fully transparent, partially transparent, translucent, or opaque. Still further, the inks used for layers 104, 106, and 108 may be white, black, reflective, absorptive, and/or colored.

The order and composition of each layer 104, 106, and 108 are designed to make a stack of ink layers on the illuminated panel that is heat resistant and durable, and which provides high contrast, high resolution images and/or patterns in either monochrome, black and white, or full color. In an exemplary embodiment shown in FIG. 3, the first layer 104 may be a printed, light absorbent black ink layer designed as a mask, so as to reduce internal reflection within the luminaire. The shape of the first layer 104 is a negative of the desired final image or pattern and leaves an open space in the shape of the final desired image. The second layer 106 may be a printed, transparent or partially transparent layer in the shape of the final desired image or pattern. The second layer 106 may be colored. The third layer 108 may be a printed, white and/or reflective layer designed as a mask, so as to reflect back unused and damaging light radiation from light beams 110 from a light source. The shape of the third layer 108 is a negative of the desired final image or pattern and leaves an open space in the shape of the final desired image or pattern.

One or more layers of ink on the substrate 102 may include a highly reflective or metallic ink. For example, the inks may include aluminum or zinc oxide and/or may include a reflective white pigment or material to increase the overall reflectivity of the inks. The inks used for any of the layers may contain dichroic material to provide colors or to enhance reflectivity. The reflectivity in the ink helps protect the substrate and ink from light energy, ultraviolet light, and infra-red energy.

One or more layers of ink on the 102 may include a highly absorptive and/or opaque ink. In particular, the ink may be black or may have any other characteristic or quality that increases absorption of light by the ink. Absorptive inks aid in absorbing stray light within the device in which the illuminated panel 100 is disposed, producing a crisper and cleaner image from the illuminated panel 100.

Any of the inks disclosed herein may further be heat resistant inks, suitable for high temperature operation.

While three layers of ink are described with respect to the embodiment of FIG. 3, any number of layers may be utilized. Further, any or all of the layers of ink printed on the substrate 102 may be the same type of ink or different types of ink.

A process of manufacturing an illuminated panel 100 including a substrate 102 and layers of ink 104, 106, 108 may follow the following steps:

a. The substrate 102 may be cleaned and/or degreased, as required. This cleaning process will vary dependent on the material used for substrate 102.

b. The substrate 102 may be pre-coated with an adhesion promoter. This step may be performed before insertion of the substrate 102 into the printer or as part of the printing process. The adhesion promoter aids in retaining the layers of ink on the substrate 102. Still optionally, an adhesion promoter may be included within a cleanser, such as an alcohol-based cleaner, to simultaneously clean the substrate 102 and increase the adhesion properties of the substrate 102.

c. The substrate 102 is inserted in the printer.

d. The printer performs at least one printing pass across the substrate 102. Multiple passes through the printer may be performed for multiple layers. Each pass across the substrate 102 may use a different ink or multiple different inks (to mimic multiple passes) so as to build up the desired sequence of layers 104, 106, and 108 as described above. Still optionally, the same ink may be applied over multiple passes, for example, to increase the saturation level or opacity of the ink. Utilizing multiple passes with the same or different inks, overstacking may be performed whereby droplets of ink are stacked upon each other or offset with respect to one another.

e. A protective layer may optionally be applied on the substrate 102 and over the layers 104, 106, and 108 to further protect the ink layers 104, 106, 108.

This process may be utilized for any number of ink layers. The number of passes through the printer is dependent on the number of layers.

The transparent substrate 102 may be a rigid or flexible material and may be mounted in a frame to provide further support, if desired. The inks used for printing the layers, for example layers 104, 106, and 108, on the substrate 102 may also be flexible such that they remain adhered to substrate 102.

In a further embodiment of the process for manufacturing an illuminated panel 100, a sheet of the substrate 102 may be run through the printer and may be imprinted with multiple copies of the same illuminated panel, or with multiple different illuminated panels. The sheet of substrate may be cut into individual illuminated panels after the images have been printed.

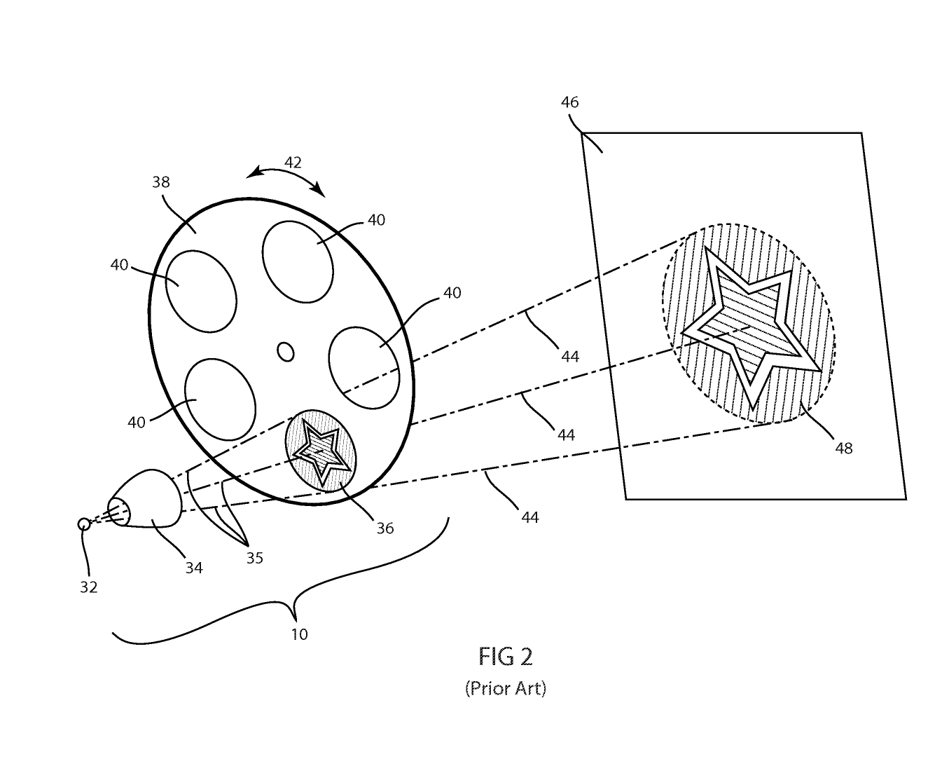

In yet a further embodiment, a wheel for holding multiple illuminated panels, such as the wheel 38 illustrated in FIG. 2, may be created as a single piece of transparent substrate material with each illuminated panel printed as multiple layers, as described herein. A single run through the manufacturing process, as described above, may provide all of the illuminated panels on the wheel, rather than needing to run through the manufacturing process once for each illuminated panel.

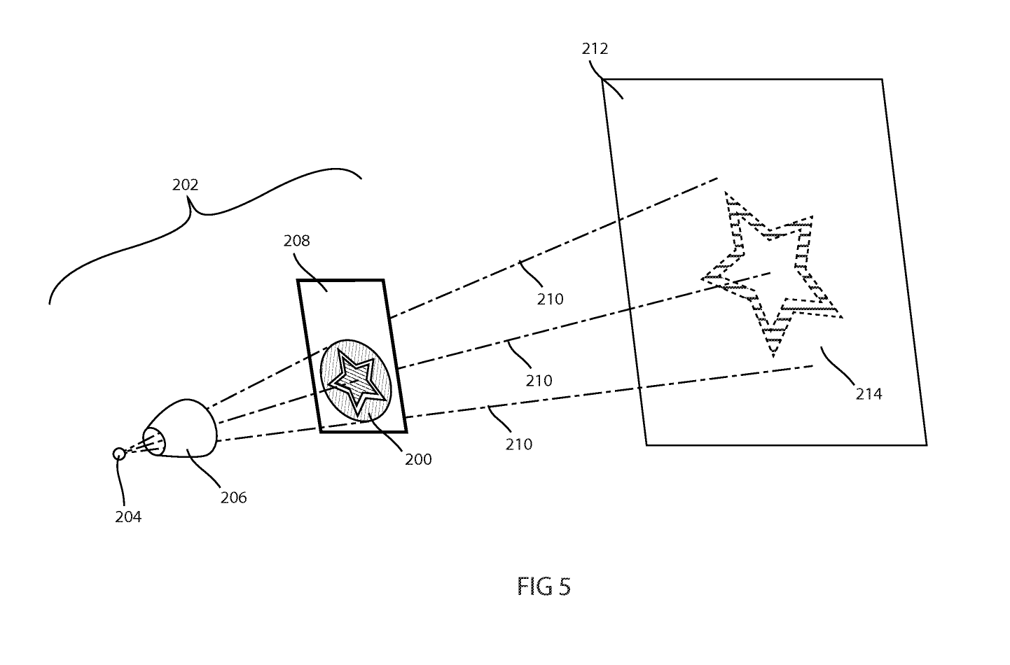

An embodiment of an illuminated panel 200 within an illuminated panel lighting system including a luminaire 202 is depicted in FIG. 5. The luminaire 202 may contain a light source 204 and light gathering system 206. Light is directed from the light source 204 to the light gathering system 206, where collimated light is directed through the illuminated panel 200, which may be supported and retained in frame or holder 208, as described in detail above. The illuminated panel 200 may be an illuminated panel as described in detail with respect to FIGS. 2-4B, comprising multiple layers of fully transparent, partially transparent, translucent, and/or reflective ink representing a desired pattern or image. Light 210 emerging from illuminated panel 200, which may be focused and directed by further optical systems within the luminaire (not shown), exits the luminaire and impinges on a projection surface 212, where a pattern or image 214 of the illuminated panel 200 is displayed.

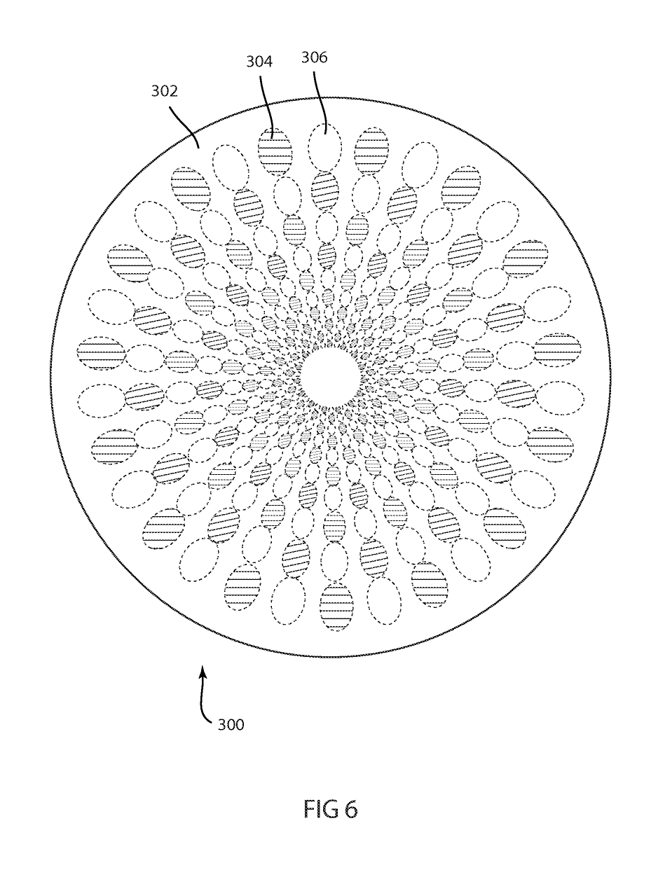

An exemplary illuminated panel 300 is depicted in FIG. 6. The illuminated panel 300 comprises a transparent substrate 302. Multiple layers of fully transparent, partially transparent, translucent, and/or reflective ink are printed on to substrate 302 so as to represent the desired pattern. The pattern illustrated utilizes at least two different partially transparent colored inks, 204 and 206, printed with a high level of detail so as to provide a high resolution, colored illuminated panel. Further printed layers of white and/or light reflective inks and black and/or light absorbing inks may also be used as mask layers, as previously described.

While the disclosure has been described with respect to a limited number of embodiments, those skilled in the art, having benefit of this disclosure, will appreciate that other embodiments may be devised which do not depart from the scope of the disclosure as disclosed herein. The disclosure has been described in detail, it should be understood that various changes, substitutions and alterations can be made hereto without departing from the spirit and scope of the disclosure.

1. A method of making an illuminated panel for projecting a pattern or an image and for use with a lighting system including a light source, the method comprising the steps of:
providing a substrate; and
printing at least one layer of ink on the substrate to create an image or pattern that may be projected onto a surface, wherein the at least one layer of ink is a light absorbent or light reflective layer of ink that helps protect the substrate and ink from light energy, ultraviolet light, and infra-red energy.

2. The method of making an illuminated panel of claim 1, further including the step of cleaning the substrate.

3. The method of making an illuminated panel of claim 2, further including the step of degreasing the substrate.

4. The method of making an illuminated panel of claim 1, further including the step of coating the substrate with an adhesion promoter, wherein the coating step occurs before the printing step.

5. The method of making an illuminated panel of claim 1, further including the step of coating the substrate with an adhesion promoter, wherein the coating step occurs during the printing step.

6. The method of making an illuminated panel of claim 1, wherein the printing step includes printing two or more layers of ink that form the image or pattern that is projected on the surface.

7. The method of making an illuminated panel of claim 6, wherein the printer performs at least two printing passes across the substrate to print the two or more layers of ink.

8. The method of making an illuminated panel of claim 7, wherein one of the layers of ink is of a light reflective ink and the other of the layers of ink is of a light absorptive ink.

9. The method of making an illuminated panel of claim 1, further including the step of applying a protective layer on the substrate over the at least one layer of ink.

10. The method of making an illuminated panel of claim 1, wherein the substrate is selected from the group consisting of glass, polycarbonate, polyester, and acrylic.

11. The method of making an illuminated panel of claim 1, wherein the printing step is undertaken by an ink-jet, laser, or a bubble-jet printer.

12. The method of making an illuminated panel of claim 1, wherein the substrate is transparent.

13. The method of making an illuminated panel of claim 1, wherein the printing step includes the step of printing multiple instances of the image or pattern on the substrate and the method further includes the step of severing each of the individual images or patterns from the substrate.

14. The method of making an illuminated panel of claim 1, wherein the printing step includes the step of simultaneously printing multiple different images or patterns on the substrate, thereby creating a wheel of images or patterns for use with a wheel for changing the image or pattern.

15. An illuminated panel for projecting an image or pattern and for use with a lighting system, the illuminated panel comprising:
a substrate; and
at least one layer of ink deposited on the substrate to form an image or pattern, wherein the at least one layer of ink is a light absorbent or light reflective layer of ink that helps protect the substrate and ink from light energy, ultraviolet light, and infra-red energy.

16. The illuminated panel of claim 15, wherein the layer of ink is a high temperature ink and the ink is cured and hardened by exposure to ultraviolet radiation.

17. The illuminated panel of claim 15, wherein the image or pattern is monochrome, black and white, or full color.

18. The illuminated panel of claim 15, wherein the substrate is a transparent material selected from the group consisting of glass, polycarbonate, polyester, and acrylic.

19. An illuminated panel for projecting an image or pattern and for use with a lighting system, the illuminated panel comprising:
a substrate;
a first layer of ink deposited on the substrate; and
a second layer of ink deposited on the substrate;
wherein one of the first and second layers is reflective and the other of the first and second layers is absorptive;
wherein the first and second layers of ink combine to form an image or pattern for projection.

20. The illuminated panel of claim 19, wherein the substrate is a transparent material selected from the group consisting of glass, polycarbonate, polyester, and acrylic.
